(19) United States
(12) Patent Application Publication
(10) Pub. No.: US 2026/0359466 A1
(43) Pub. Date: Nov. 12, 2026

(54) Sensitive Content Sharing

(71) Applicant: Proofpoint, Inc., Sunnyvale, CA (US)

(72) Inventors: Ruth Coen-Soae, Jerusalem (IL); Sveta Sitruk, Lexington, MA (US); Oleg Zibulkin, Tel Aviv (IL); Luda Margolis Schechter, Doylestown, PA (US); Lior Tal, Tel Aviv (IL); Efim Kuimov, Tel Aviv (IL); Nir Barak, Karmy Yosef (IL)

(21) Appl. No.: 19/205,105

(22) Filed: May 12, 2025

(51) Int. Cl. G06F 21/62

(52) U.S. Cl. CPC G06F 21/6218

(57) ABSTRACT

An indication that an endpoint device has initiated sharing of share content is received. Each portion of the share content is identified as either sensitive content or non-sensitive content. For each portion of the share content identified as sensitive content, redacted sensitive content is generated. The redacted sensitive content and the non-sensitive content are shared.

### FIELD

This disclosure relates generally to data loss prevention and, more specifically, to preventing users from sharing sensitive content in screen shares during video conference calls.

### BACKGROUND

Insider Threat Management (ITM) systems automatically collect large amounts of information relating to users' activities at endpoint devices in a company's computer network. Such ITM systems generally process the collected information to identify possible insider threats.

### SUMMARY

A method for preventing sensitive content sharing is described. An indication that an endpoint device has initiated sharing of share content is received. Each portion of the share content is identified as either sensitive content or non-sensitive content. For each portion of the share content identified as sensitive content, redacted sensitive content is generated. The redacted sensitive content and the non-sensitive content are then shared.

The sharing may be a screen share for a video conference. Generating the redacted sensitive content may include inserting blocking material to cover the sensitive content. Generating the redacted sensitive content may also include cutting the sensitive content out of the share content. The endpoint device may display a prompt notifying a user of the endpoint device of the sensitive content. The prompt may provide the user with a first option to share the sensitive content and a second option to redact the sensitive content. When the first option is selected, a notification may be provided to an administrator indicating the sensitive content has been shared. The notification may be a screen shot of the sensitive content and metadata associated with the sharing. When the second option is selected, the sensitive content may be redacted according to content sharing rules.

The content sharing rules may be managed by an administrator that also manages the endpoint device. The sensitive content may be identified based on metadata associated with the share content. The sensitive content may be identified using a text search of the share content. A first redaction option may be applied to a first type of the identified sensitive content and a second redaction option may be applied to a second type of the identified sensitive content.

A computing platform for preventing sensitive content sharing is also described. The computing platform includes a memory and a processor. The processor is configured to execute instructions stored in the memory to receive an indication that an endpoint device has initiated sharing of share content. The processor is also configured to execute instructions stored in the memory to identify each portion of the share content as either sensitive content or non-sensitive content. The processor is further configured to execute instructions stored in the memory to generate redacted sensitive content for each portion of the share content identified as sensitive content. The processor is also configured to execute instructions stored in the memory to share the redacted sensitive content and the non-sensitive content.

The processor may be further configured to execute instructions stored in the memory to cause the endpoint device to display a prompt notifying a user of the endpoint device of the sensitive content. The prompt may provide the user with a first option to share the sensitive content and a second option to redact the sensitive content. When the first option is selected, a notification may be provided to an administrator indicating the sensitive content has been shared. The notification may include a screen shot of the sensitive content and metadata associated with the sharing.

A non-transitory computer readable medium storing instructions operable to cause one or more processors to perform operations for preventing sensitive content sharing is described. The instructions are operable to cause the one or more processors to receive an indication that an endpoint device has initiated sharing of share content. The instructions are also operable to cause the one or more processors to identify each portion of the share content as either sensitive content or non-sensitive content. The instructions are further operable to cause the one or more processors to generate redacted sensitive content for each portion of the share content identified as sensitive content. The instructions are also operable to cause the one or more processors to share the redacted sensitive content and the non-sensitive content.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an operating environment for preventing the sharing of sensitive content during screen shares.

FIG. 2 is a block diagram of an endpoint device configured for preventing the sharing of sensitive content during screen shares.

FIG. 3 is an example of a technique preventing the sharing of sensitive content during screen shares in a video conference.

FIG. 4 is an example of a technique for using blocking material to cover sensitive content in share content that a user of an endpoint device is attempting to share.

FIG. 5 depicts illustrative user interfaces for a source screen of an endpoint device that is being shared with a target screen of a user computing device during a video conference.

FIG. 6 depicts other illustrative user interfaces for a source screen of an endpoint device that is being shared with a target screen of a user device during a video conference.

FIG. 7 is an example of a technique for notifying a user of an endpoint device that they are attempting to share sensitive information in share content.

### DETAILED DESCRIPTION

Insider Threat Management (ITM) systems automatically collect various types of data and/or metadata relating to users' activities at endpoint devices on a company's computer network. The collected information may be analyzed to determine whether any of the associated users' activities might amount to a possible insider threat, such as an attempt at exfiltrating confidential company data from its computer networks. If any such threats are identified, the system flags those threats to a system administrator, for example, who can then take appropriate corrective measures if needed.

Data protection and data privacy are of paramount importance in today's connected society and are becoming more and more important almost every day. Additionally, companies, their customers/clients, and the public have, over time, become more aware of and sensitive to these sorts of issues and concerns.

During a video conference, users often share live versions of their screen (“screen sharing”). This allows for better collaboration and quickly conveying information that would otherwise need to be shared via email, which is tedious and disruptive. A user may select to share either a specific application/window running on their endpoint device (such as a single word document or a slide presentation) or a screen share (which shares the entire visible desktop of the user) with other attendees of the video conference. Screen sharing is often performed ad-hoc, meaning that the applications for screen sharing may not have been reviewed to determine whether they include private information prior to the user initiating the screen sharing. This can result in private/sensitive information being inadvertently shared with people that should not have access to the private/sensitive information. For example, a user may begin screen sharing a word document in a meeting without realizing that the word document includes private information about the user (such as the user's credit card information). As another example, a user may begin screen sharing a slide presentation in a meeting that includes proprietary company information.

A data loss prevention (DLP) agent on the user endpoint device may monitor the information that a user attempts to screen share during video conferences. The DLP agent may then prevent portions of that screen share from being shared with other attendees of the video conferences. For example, the DLP agent may cover some or all of a window of the screen share with a black box or a gray shading to prevent portions of the screen share that include private information from being shared. The DLP agent may also notify the user that they are potentially sharing private or sensitive information (via a prompt) and ask them to either confirm that they are aware of this and move forward with sharing the material or stop the screen share. The DLP agent does not prevent the user endpoint device from sharing non-private information.

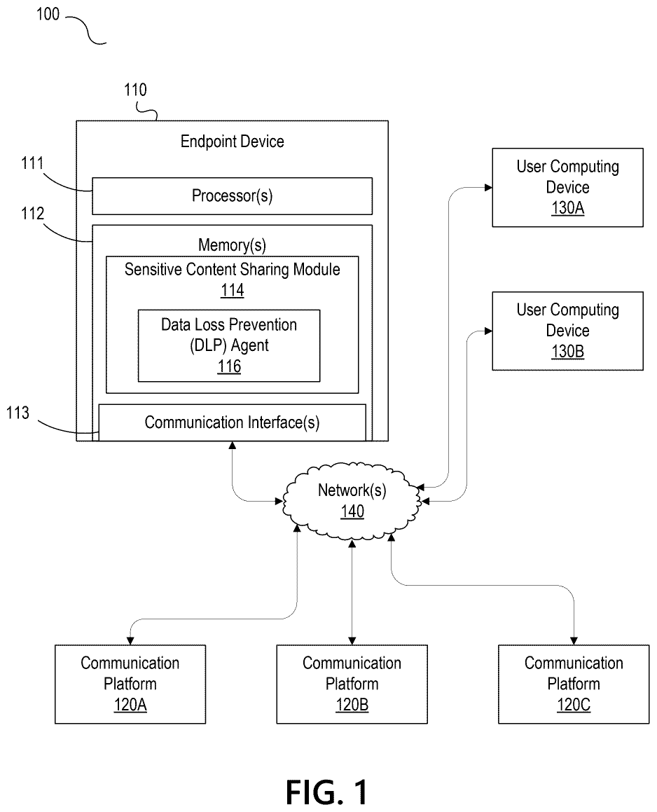

FIG. 1 depicts an illustrative operating environment for preventing the sharing of sensitive content during screen shares. Referring to FIG. 1, a computing environment 100 may include various computer systems, computing devices, networks, and/or other operating infrastructure. For example, the computing environment 100 may include an endpoint device 110, communication platforms 120, user computing devices 130, and one or more network(s) 140.

Network(s) 140 may include one or more wired networks and/or one or more wireless networks that interconnect the endpoint device 110, communication platforms 120, user computing devices 130, and/or other computer systems and/or devices. In addition, each of the endpoint device 110, communication platforms 120, and user computing devices 130 may be special purpose computing devices configured to perform specific functions, as illustrated in greater detail below, and may include specific computing components such as processors, memories, communication interfaces, and/or the like.

The endpoint device 110 may include one or more processor(s) 111, one or more memory(s) 112, and one or more communication interface(s) 113. In one or more arrangements, processor(s) 111 may control operations of the endpoint device 110. Memory(s) 112 may store instructions that, when executed by the processor(s) 111, cause the endpoint device 110 to perform one or more functions, as discussed below. The communication interface(s) 113 may include one or more wired and/or wireless network interfaces, and the communication interface(s) 113 may connect the endpoint device 110 to one or more networks (e.g., network 140) and/or enable the endpoint device 110 to exchange information and/or otherwise communicate with one or more devices connected to such networks, such as the user computing devices 130a-b.

In one or more arrangements, memory(s) 112 may store and/or otherwise provide a plurality of modules (which may include instructions that may be executed by processor(s) 111 to cause the endpoint device 110 to perform various functions) and/or databases (which may store data used by the endpoint device 110 in performing various functions). For example, the memory(s) 112 may store and/or otherwise provide a sensitive content sharing module 114 that includes a data loss prevention (DLP) agent 116. The sensitive content sharing module 114 may utilize the data loss prevention (DLP) agent 116 to analyze screen content or an entire document that a user of the endpoint device 110 has indicated they wish to share, including screen content or an entire document that is currently being shared with the user computing devices 130a-b during a video conference. The sensitive content sharing module 114 may provide content shielding to the screen content that has been analyzed and determined to include private and/or sensitive information. For example, the sensitive content sharing module 114 may prevent certain windows from being shared during a video conference by redacting the windows (either removing them from the screen share or covering them with a content shield). The DLP agent 116 may analyze the entirety of a document being shared (including portions of the document that are not seen currently on the user's screen) so that if the user does scroll up or down while sharing the document, those portions of the document that include private information are not shared in the screen share.

The user computing devices 130 may be configured to be used by respective users to join and participate in video conferences via the communication platforms 120a-c. The user computing devices 130 could be user-owned devices, employer-provided devices, or other types of devices used by respective users. The user computing devices 130 may be configured to present one or more user interfaces associated with messaging functions as described below.

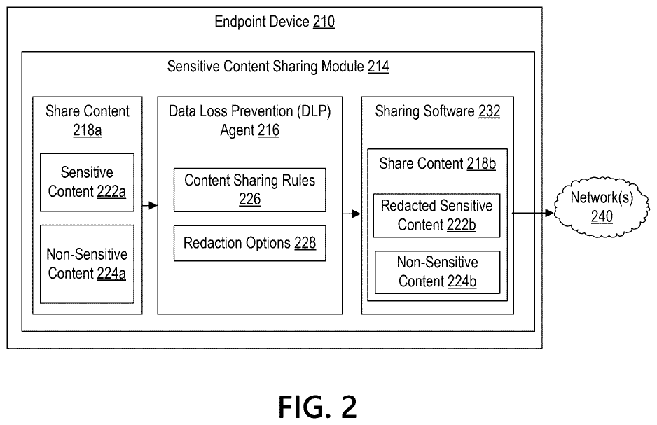

FIG. 2 is a block diagram of an endpoint device 210 configured for preventing the sharing of sensitive content during screen shares. The endpoint device 210 may be a work device or a personal device that has been configured for use on a company's computer network 240. For example, the endpoint device 210 may be a work laptop, a work cell phone, a personal desktop, or other device that has been updated to include a sensitive content sharing module 214. In some configurations, the endpoint device 210 may be managed or controlled by a system administrator of the company (e.g., the employer of the user of the endpoint device 210).

The sensitive content sharing module 214 may be used to prevent the intentional or unintentional exposure of company or personal data by the endpoint device 210 as part of a video conference. The sensitive content sharing module 214 may be managed/controlled by the company (such as by an administrator of the company) or by the user of the endpoint device 210. The sensitive content sharing module 214 may act as a filter or shield to prevent sensitive content 222a from being shared in a screen share (or a screen shot) during a video conference.

The sensitive content sharing module 214 may include share content 218a. The share content 218a may include sensitive content 222a and non-sensitive content 224a. Sensitive content 222a may refer to content that has been deemed sensitive (either by the company, an administrator of the company, or the user of the endpoint device 210). Examples of sensitive content 222a include confidential company data, personally identifiable information (PII) (such as people's names, social security numbers, genders, birthdates, addresses, phone numbers, email addresses, biometric data, medical records, education records, financial records, employment records, sex or gender identity, geographic location, racial information, or a disease diagnosis), customer data (such as customer lists, sales records, emails, and employee databases), and personal data (such as emails and chats received by a user of the endpoint device 210 during a video conference, photographs, and an email inbox record). Non-sensitive content 224a may include all other content that could be shared in a screen share during a video conference, including slides, word documents, and spreadsheets.

During a video conference, a user of the endpoint device 210 may select share content 222a that they wish to share with other attendees of the video conference. This share content 222a may be selected by a user selecting a particular screen to share (such as a first monitor), an application to share (such as a word document or a web browser), a portion of a screen to share (such as a manually selected portion of the screen that includes multiple applications but does not include the entire screen), or background imagery captured by a camera on the endpoint device 210 (such as content written on a physical whiteboard that is within the frame captured by the endpoint device 210). Thus, a user of the endpoint device 210 may select both sensitive content 222a and non-sensitive content 224a for sharing during a video conference. The user of the endpoint device 210 may be unaware that the share content 218a includes both sensitive content 222a and non-sensitive content 224a, and the share content 218a may not yet be defined as sensitive content 222a or non-sensitive content 224a when the user of the endpoint device 210 elects to begin sharing the share content 218a. For example, in some configurations the share content 218a may not be evaluated to determine whether it includes sensitive content 222a until a user of the endpoint device 210 has initiated screen sharing.

The share content 218a selected for sharing may be provided to a data loss prevention (DLP) agent 216 of the sensitive content sharing module 214 when a user of the endpoint device 210 has initiated screen sharing. The DLP agent 216 may determine whether the selected share content 218a is sensitive content 222a or non-sensitive content 224a. If the DLP agent 216 determines that sensitive content 222a has been selected by the user of the endpoint device 210 for screen sharing, the DLP agent 216 may determine whether to apply a content shield to the sensitive content 222a based on content sharing rules 226. The content shield is only applied on what is shared during a screen share (the user of the endpoint device 210 will continue to see the sensitive content 222a on their own screen). Applying a content shield may include blocking the sensitive content 222a (e.g., covering the sensitive content 222a with a black or other color cover, blurring the sensitive content 222a, or cutting the sensitive content out of the screen share (removing the sensitive content 222a from the share content 218b that is shared during the video conference)) to form redacted sensitive content 222b. The content sharing rules 226 may be continuously updated based on changes to definitions of what is sensitive content 222a and what sensitive content 222a is acceptable for a particular user to share. Thus, it may be possible for share content 218a to be labeled as non-sensitive content 224a at the beginning of a video conference and then be identified as sensitive content 222a and redacted before the end of the video conference.

The DLP agent 216 may be managed by an administrator of the company. For example, the DLP agent 216 may obtain content sharing rules 226 from the administrator. The content sharing rules 226 may define which sensitive content 222a should be redacted from screen sharing during a video conference. For example, the content sharing rules 226 may indicate that the user of the endpoint device 210 has a rank within the company that allows them to share certain sensitive content 222a (such as pictures and contact information for customers of the company) with all people (e.g., based on a trust level assigned to employees of that rank or a trust level assigned to the specific user), that allows them to share limited employment information with specific attendees of the video conference (such as other members of the same team or trusted external users), and that redacts all personally identifiable information (PII) from being shared by that user for any video conferences, regardless of the attendees. The content sharing rules 226 may thus link the history of the user attempting to share sensitive content 222a with the specific types of sensitive content 222a they are attempting to share. The content sharing rules 226 may apply to labeled content (such as documents or webpages that have already been identified as sensitive content 222a and have been labeled as such with metadata indicating the type of sensitive content 222a). The content sharing rules 226 may also apply to live content (such as a webpage on a browser of the endpoint device 210 that is updating in real time during the screen share). For live content, the DLP agent 216 may introduce a small delay to allow the DLP agent 216 to scan the live content for potential sensitive content 222a and apply the content sharing rules 226 before that share content 218a is visible to other attendees of the video conference.

In some configurations, the DLP agent 216 may inform the user of the endpoint device 210 that they are attempting to share sensitive content 222a that is prohibited from being shared under the content sharing rules 226. For example, the DLP agent 216 may cause a pop-up window to be displayed on a screen of the endpoint device 210 that identifies the sensitive content 222a, the content sharing rules 226 potentially being violated, and/or the potential consequences of such a violation. The pop-up window may be strict (meaning the user of the endpoint device 210 is unable to share the identified sensitive content 222a) or informative (meaning the user of the endpoint device 210 can select to bypass the restriction on sharing the sensitive content 222a) depending on the configuration. In one configuration, the pop-up window may inform the user of the endpoint device 210 that screenshots of the sensitive content 222a that is shared based on the user bypassing the content sharing rules 226 may be provided to a DLP administrator of the company for further analysis.

The user of the endpoint device 210 may be able to select from multiple redaction options 228 provided by the sensitive content sharing module 214. For example, the user of the endpoint device 210 may be able to select from a black cover, a transparent cover (such that any content or a desktop image behind the sensitive content 222a is displayed), or a blurring of the sensitive content 222a. Thus, the redaction options 228 selected by the user of the endpoint device 210 may be applied to the sensitive content 222a to obtain redacted sensitive content 222b. In one configuration, different redaction options 228 may be applied to different types of sensitive content 222a. For example, PII may be covered by a blue cover while biometric records may be covered by a red cover. The redaction options 228 may be preset by the user or by an administrator, such that when new sensitive content 222a is selected for sharing during a video conference, preset redaction options 228 may immediately be applied.

Sharing software 232 (such as that provided by the provider of the video conference) may receive the share content 218b, including the redacted sensitive content 222b and/or the non-sensitive content 224b. The share content 218b (including both the non-sensitive content 224b and the redacted sensitive content 222b) may then be provided to the other attendees of the video conference via the network 240.

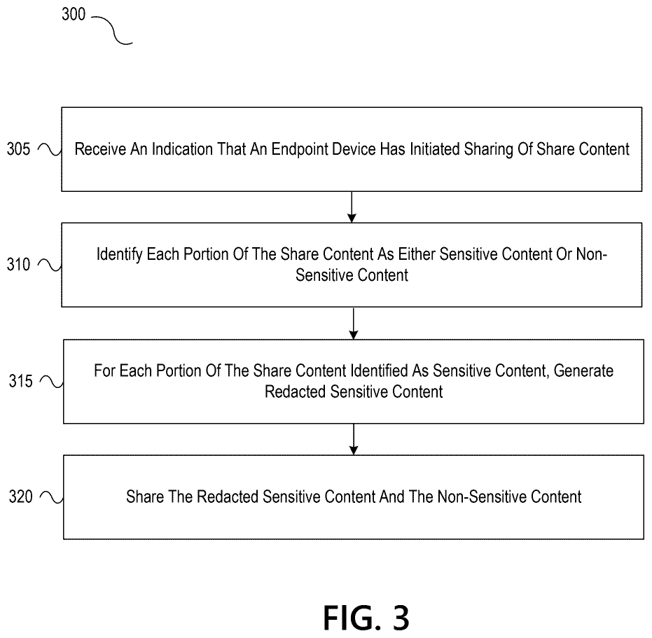

FIG. 3 is an example of a technique 300 for preventing the sharing of sensitive content during screen shares in a video conference. The technique 300 can be executed using computing devices, such as the systems, hardware, and software described with respect to FIGS. 1-2. The technique 300 can be performed, for example, by executing a machine-readable program or other computer-executable instructions, such as routines, instructions, programs, or other code. The steps, or operations, of the technique 300 or another technique, method, process, or algorithm described in connection with the implementations disclosed herein can be implemented directly in hardware, firmware, software executed by hardware, circuitry, or a combination thereof. The technique 300 can be performed by a software platform or by software on an endpoint device 210.

At 305, an indication that an endpoint device has initiated sharing of share content 218 is received. If the technique 300 is performed by a software platform, the indication that the endpoint device 210 has initiated sharing of share content 218a may be received from the endpoint device 210. If the technique 300 is performed on the endpoint device 210, the indication that the endpoint device 210 has initiated sharing of share content 218a may be received from video conferencing software. For example, the indication may be that the user of the endpoint device 210 has clicked the “share my screen” button within the user interface (UI) of the video conferencing software. In one configuration, the indication that an endpoint device 210 has initiated sharing of share content 218a may be in response to a user initiating a screenshot button on the endpoint device 210. In one configuration, any window that includes sensitive content 222a may be always redacted (which will not prevent the user of the endpoint device 210 from seeing the sensitive content 222a but will prevent any users viewing the window through a video sharing application from seeing the sensitive content 222a). The indication that an endpoint device 210 has initiated sharing of share content 218a may include an indication of the share content 218a and any metadata associated with the share content 218a (such as whether the share content 218a has been labeled as sensitive content 222a or non-sensitive content 224a).

At 310, each portion of the share content 218a is identified as either sensitive content 222a or non-sensitive content 224a. In one configuration, the share content 218a may be identified as either sensitive content 222a or non-sensitive content 224a based on metadata associated with the share content 218a. The metadata may indicate specific portions of a document that are sensitive content 222a or non-sensitive content 224a or the metadata may indicate that an entire document is sensitive content 222a or non-sensitive content 224a. In another configuration, text and/or image scanning may be performed on the share content 218a to determine whether the share content 218a is sensitive content 222a or non-sensitive content 224a. For example, a document selected for sharing may be scanned to determine whether the document includes potential social security numbers; if the document includes any numbers of the format XXX-XX-XXXX, the document may be flagged as sensitive content 222a.

At 315, for each portion of the share content 218a that has been identified as sensitive content 222a, a redacted version of the sensitive content 222a (i.e., redacted sensitive content 222b) is generated. The redacted sensitive content 222b may be generated by covering the sensitive portions of the document with opaque boxes, blurring the sensitive portions of the document, or even completely removing the document from being shared (for example, during a screen share where multiple applications are shared, the application that has been identified as sensitive content 222a may be cut out of the share content 218a).

At 320, the redacted sensitive content 222b and the non-sensitive content 224b may be shared as part of share content 218b. For example, if the user of the endpoint device 210 is attending a video conference, the redacted sensitive content 222b and the non-sensitive content 224b may be shared with other participants of the video conference. As another example, if the user of the endpoint device 210 is taking a screen shot, a screen shot is generated that includes the redacted sensitive content 222b and the non-sensitive content 224b and made available for the user of the endpoint device 210 to share (such as via a video conference, email, chat, or other sharing mechanism).

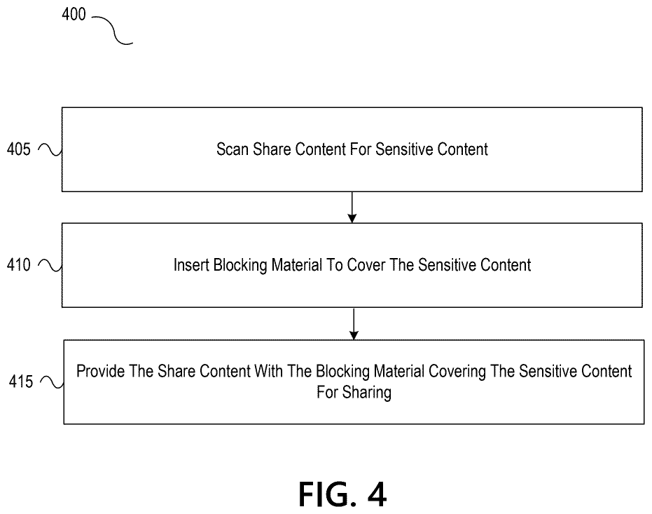

FIG. 4 is an example of a technique 400 for using blocking material to cover sensitive information in share content 218a that a user of an endpoint device 210 is attempting to share. The technique 400 can be executed using computing devices, such as the systems, hardware, and software described with respect to FIGS. 1-2. The technique 400 can be performed, for example, by executing a machine-readable program or other computer-executable instructions, such as routines, instructions, programs, or other code. The steps, or operations, of the technique 400 or another technique, method, process, or algorithm described in connection with the implementations disclosed herein can be implemented directly in hardware, firmware, software executed by hardware, circuitry, or a combination thereof. The technique 400 can be performed by a software platform or by software on an endpoint device 210.

At 405, share content 218a is scanned for sensitive information. The share content 218a may be content that a user of the endpoint device 210 has selected for sharing, such as an application on the endpoint device 210, an application that is open on a screen of the endpoint device 210 (e.g., for a “share my screen” sharing option), or material that is captured by the camera of the endpoint device 210 (which is not blocked by a virtual background). The share content 218a may be scanned for sensitive content 222 according to one or more content sharing rules 226 that define which content is sensitive and/or which sensitive content 222a must be covered by blocking material during a video conference.

At 410, blocking material is inserted to cover the sensitive content 222a. The blocking material may be a virtual covering (such as a virtual black box) that covers either the entire application that has been determined to include sensitive information or only the portions of the application or screen determined to be sensitive content 222a. The blocking material may be selected by a user of the endpoint device 210 or the blocking material may be preselected by an administrator of the endpoint device 210 (e.g., according to a company mandate for how to prevent screen sharing of sensitive content 222a).

At 415, the share content 218b with the blocking material covering the sensitive content 222b may be provided to sharing software 232 for sharing. For example, the sharing software 232 may be video conferencing software that then provides the share content 218b with the non-sensitive content 224b and the blocking material covering the sensitive content 222b to other attendees of a video conference.

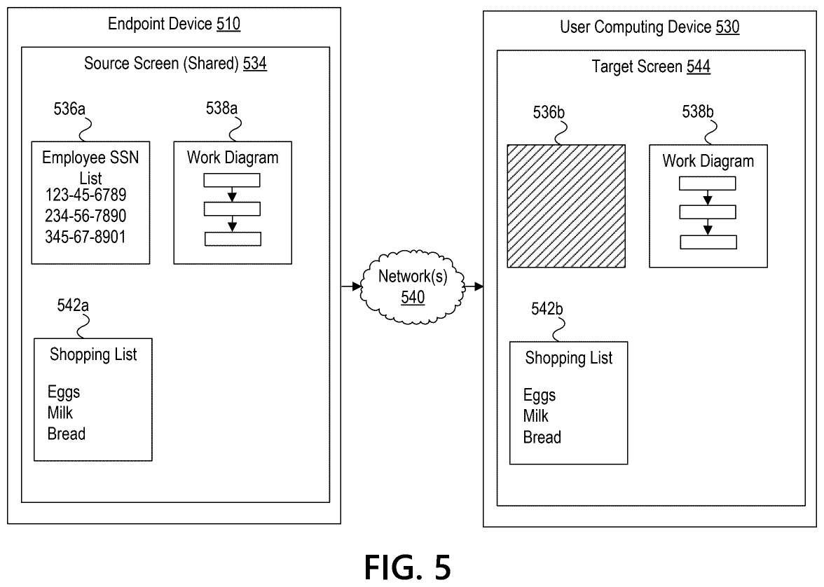

FIG. 5 depicts illustrative user interfaces for a source screen 534 of an endpoint device 510 that is being shared with a target screen 544 of a user computing device 530 during a video conference. In the user interfaces shown, the user of the source screen (shared) 534 has already initiated screen sharing during the video conference with a user of the user computing device 530. The video conference may allow the sharing of files (including screen sharing) between multiple devices over a network 540.

In the source screen (shared) 534, three windows or applications are open. In a first window 536a, an employee SSN list is shown with three numbers that appear to be SSN numbers: 123-45-6789, 234-56-7890, and 345-67-8901. In a second window 538a, a work diagram is shown (such as presentation slides). In a third window 542a, a shopping list is shown with three shopping items: eggs, milk, and bread. The user of the endpoint device 510 has attempted to share the entire source screen 534 (to share the first window 536a, the second window 538a, and the third window 542a) with the user computing device 530. However, the first window 536a has been determined to include sensitive content 222a and has not been shared.

In the target screen 544 of the user computing device 530, the screen share of the endpoint device 510 is being displayed. The first window 536b, which included sensitive content 222b, has been covered to prevent the sensitive information within the first window from being shown to the user of the user computing device 530. The second window 538b and the third window 542b do not include sensitive information (as defined by the content sharing rules 226) and thus are displayed on the target screen 544 without a cover.

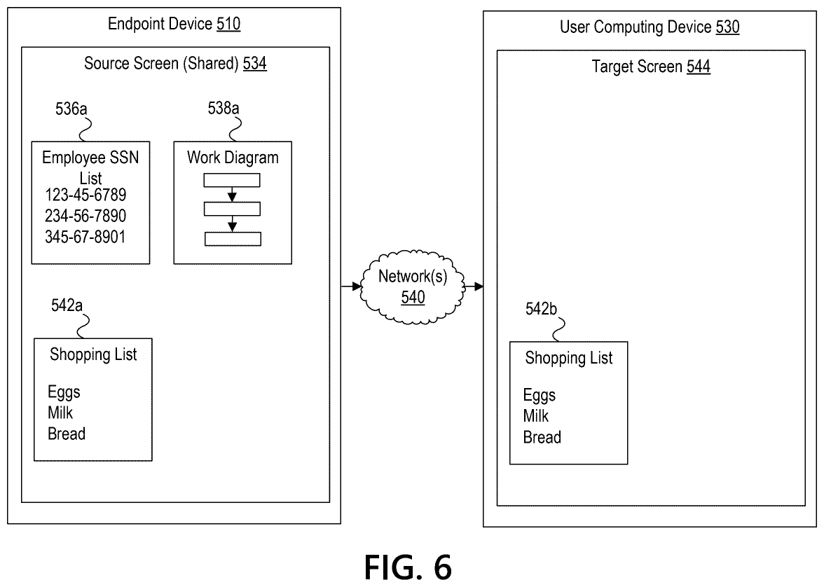

FIG. 6 depicts other illustrative user interfaces for a source screen 534 of an endpoint device 510 that is being shared with a target screen 544 of a user computing device 530 during a video conference. In the user interfaces shown, the user of the endpoint device 510 has already initiated screen sharing during the video conference with a user of the user computing device 530 over the network. In this example, both the first window 536a and the second window 538a have been determined to include sensitive content 222a according to the content sharing rules 226. The selected redaction option 228 is to cut the sensitive content 222a completely out of the share content 218b provided to attendees of the video conference by the sharing software 232.

In the target screen 544 of the user computing device 530, the share content 222b provided by the endpoint device 510 is being displayed. The first window 536a, which includes sensitive content 222a, is not shown (it has been cut from the screen sharing) on the target screen 544. The second window 538a is also not shown on the target screen 544 based on the content sharing rules 226. The third window 542b, which includes only non-sensitive content 224b, is shown on the target screen 544 exactly as it was displayed on the source screen (shared) 534. Thus, the user of the endpoint device 510 has been prevented from accidentally or intentionally sharing sensitive content 222a during the video conference when sharing their source screen (shared) 534.

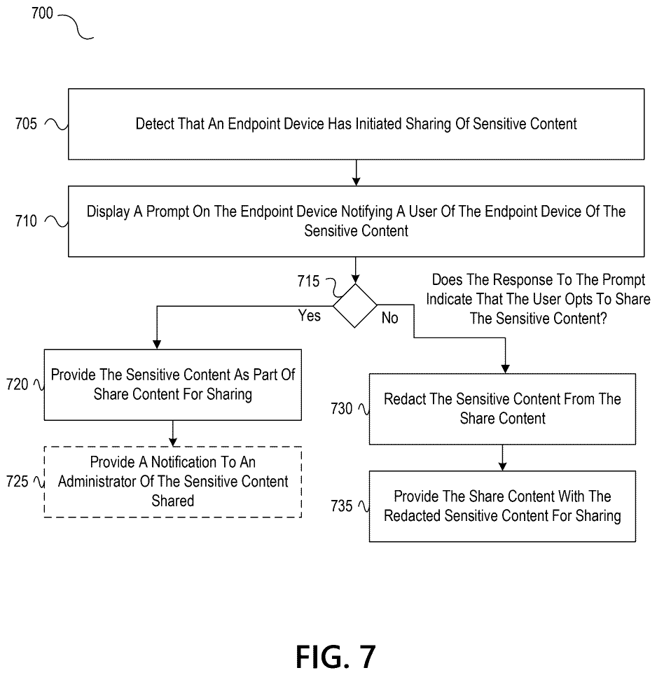

FIG. 7 is an example of a technique 700 for notifying a user of an endpoint device that they are attempting to share sensitive information in share content. The technique 700 can be executed using computing devices, such as the systems, hardware, and software described with respect to FIGS. 1-2. The technique 700 can be performed, for example, by executing a machine-readable program or other computer-executable instructions, such as routines, instructions, programs, or other code. The steps, or operations, of the technique 700 or another technique, method, process, or algorithm described in connection with the implementations disclosed herein can be implemented directly in hardware, firmware, software executed by hardware, circuitry, or a combination thereof. The technique 700 can be performed by a software platform or by software on an endpoint device 210.

At 705, a detection is made that an endpoint device 210 has initiated sharing of sensitive content 222a. The detection may be performed by the endpoint device 210 (e.g., by software controlled by a company that manages the endpoint device 210) or by an external software platform (e.g., a software platform running on a server). If the detection is performed by a software platform external to the endpoint device 210, the endpoint device 210 may collect information about attempted screen shares (including whether the share content 218a appears to include sensitive content 222a) and provide this information to the external software platform. The detection may be based on a text search of the share content 218a, an image scan of the share content 218a, or metadata associated with the share content 218b indicating that the share content 218a includes sensitive content 222a.

At 710, the endpoint device 210 displays a prompt notifying the user of the endpoint device 210 of the sensitive content 222a. The software platform or a DLP agent 216 on the endpoint device 210 may cause the endpoint device 210 to display the prompt. In one configuration, the prompt may be a pop-up window that must be cleared before the endpoint device 210 will begin sharing the share content 218a. The prompt may indicate which content of the share content 218a has been deemed to be sensitive content 222a. For example, the prompt may identify that the first window 536a of the source screen (shared) 534 of the endpoint device 510 includes sensitive content 222a. In one configuration, the prompt may also identify the type of the sensitive content 222a (e.g., PII, sensitive company information).

The prompt may also provide options for the user of the endpoint device 210. For example, the prompt may indicate that the user can choose to override the prompt (i.e., share the sensitive content 222a with the other attendees of the video conference). The prompt may indicate that if the user does override the prompt, the context of the screen share (including a screen shot or a video recording of the source screen (shared) 534 that is shared during the video conference) may be provided to an administrator of the employer of the user of the endpoint device 510. The prompt may also allow the user of the endpoint device 510 to select which windows to override (e.g., override the first window 536a of the source screen (shared) 534 but redact the second window 538a of the source screen (shared) 534). The prompt may further provide redaction options 228 to the user (such as whether to apply a cover or simply cut the sensitive content 222a out of the share content 218a, whether the cover should be a particular color, or whether the entire window having sensitive content 222a should be covered or just the portions of the share content 219a that are sensitive content 222a). In one configuration, the prompt may allow the user of the endpoint device 510 to indicate that the content identified as sensitive content 222a is not sensitive (for example, that the digits that appear to be an SSN are actually an invoice number that is not sensitive). The DLP agent 216 may then use this indication to better identify sensitive content 222a and non-sensitive content 224a in the future.

At 715, it is determined whether a response to the prompt indicates that the user of the endpoint device 210 opts to share the identified sensitive content 222a or to not share the identified sensitive content 222a.

At 720, in response to determining that the user of the endpoint device has opted to share the identified sensitive content 222a, the sensitive content 222a is provided as part of the share content 218b. For example, the sensitive content 222a may be provided for display on one or more target screens 544 of one or more user computing devices 530 as part of a video conference.

At optional step 725, an administrator (such as a systems administrator for a company that manages the user of the endpoint device 210 and/or manages the endpoint device 210) may be provided with a notification of the identified sensitive content 222a being shared in the video conference. For example, the administrator may receive an email or a pop-up indicating that the user has chosen to override the DLP agent 216 regarding the identified sensitive content 222a. The indication may also include one or more screen shots of the identified sensitive content 222a that is being shared and/or metadata associated with the sharing (such as who the attendees of the video conference are, the domain names of their logins for the video conference, and information about their roles or titles).

At step 730, in response to determining that the user of the endpoint device 210 has opted to redact (or not share) the identified sensitive content 222a as part of the screen share or share content 218a, the sensitive content 222a is redacted from the share content 218b. The redaction may be performed based on company managed settings or based on selections by the user of the endpoint device 210.

At step 735, the share content 218b is provided (with the identified sensitive content 222a redacted) for sharing to other attendees of the video conference. The other attendees may thus be able to see the share content 218b on their target screens 544 while not being able to see the sensitive content 222a (and instead being able to see the redacted sensitive content 222b).

For simplicity of explanation, the techniques 300, 400, and 700 of FIGS. 3, 4, and 7 are depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving an indication that an endpoint device has initiated sharing of share content;
identifying each portion of the share content as either sensitive content or non-sensitive content;
for each portion of the share content identified as sensitive content, generating redacted sensitive content; and
sharing the redacted sensitive content and the non-sensitive content.

2. The method of claim 1, wherein the sharing is a screen share for a video conference.

3. The method of claim 1, wherein generating the redacted sensitive content comprises inserting blocking material to cover the sensitive content.

4. The method of claim 1, wherein generating the redacted sensitive content comprises cutting the sensitive content out of the share content.

5. The method of claim 1, further comprising:
causing the endpoint device to display a prompt notifying a user of the endpoint device of the sensitive content, wherein the prompt provides the user with a first option to share the sensitive content and a second option to redact the sensitive content.

6. The method of claim 5, wherein when the first option is selected, a notification is provided to an administrator indicating the sensitive content has been shared.

7. The method of claim 6, wherein the notification comprises a screen shot of the sensitive content and metadata associated with the sharing.

8. The method of claim 6, wherein when the second option is selected, the sensitive content is redacted according to content sharing rules.

9. The method of claim 8, wherein the content sharing rules are managed by an administrator that also manages the endpoint device.

10. The method of claim 1, wherein the sensitive content is identified based on metadata associated with the share content.

11. The method of claim 1, wherein the sensitive content is identified using a text search of the share content.

12. The method of claim 1, wherein a first redaction option is applied to a first type of the identified sensitive content and a second redaction option is applied to a second type of the identified sensitive content.

13. A computing platform, comprising:
a memory; and
a processor, the processor configured to execute instructions stored in the memory to:
receive an indication that an endpoint device has initiated sharing of share content;
identify each portion of the share content as either sensitive content or non-sensitive content;
for each portion of the share content identified as sensitive content, generate redacted sensitive content; and
share the redacted sensitive content and the non-sensitive content.

14. The computing platform of claim 13, wherein the processor is further configured to execute instructions stored in the memory to:
cause the endpoint device to display a prompt notifying a user of the endpoint device of the sensitive content, wherein the prompt provides the user with a first option to share the sensitive content and a second option to redact the sensitive content.

15. The computing platform of claim 14, wherein when the first option is selected, a notification is provided to an administrator indicating the sensitive content has been shared.

16. The computing platform of claim 15, wherein the notification comprises a screen shot of the sensitive content and metadata associated with the sharing.

17. A non-transitory computer readable medium storing instructions operable to cause one or more processors to perform operations comprising:
receiving an indication that an endpoint device has initiated sharing of share content;
identifying each portion of the share content as either sensitive content or non-sensitive content;
for each portion of the share content identified as sensitive content, generating redacted sensitive content; and
sharing the redacted sensitive content and the non-sensitive content.

18. The non-transitory computer readable medium of claim 17, wherein the sharing is a screen share for a video conference.

19. The non-transitory computer readable medium of claim 17, wherein generating the redacted sensitive content comprises inserting blocking material to cover the sensitive content.

20. The non-transitory computer readable medium of claim 17, wherein generating the redacted sensitive content comprises cutting the sensitive content out of the share content.
